(19) United States
(12) Patent Application Publication
(10) Pub. No.: US 2001/0041206 A1
(43) Pub. Date: Nov. 15, 2001

(54) Method and apparatus for pressure processing a pumpable substance

(76) Inventors: Chidambaram Raghavan, Kent, WA (US); Olivier L. Tremoulet, Edmonds, WA (US); Mohamed A. Hashish, Bellevue, WA (US); Edmund Ting, Kent, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/907,722

(22) Filed: Jul. 17, 2001

Related U.S. Application Data
(63) Continuation of application No. 09/300,204, filed on Apr. 27, 1999, now abandoned.
Application No. 09/300,204 is a continuation-in-part of application No. 09/099,899, filed on Jun. 18, 1998, now Pat. No. 6,164,930.

(51) Int. Cl. A23C 3/07; A23L 3/26; A23C 3/02; A23C 3/00; A23L 3/28; A23L 3/30

(52) U.S. Cl. 426/523; 99/483; 99/470; 99/451

(57) ABSTRACT

An apparatus and method for pressure processing a pumpable substance, such as a pumpable food product. In one embodiment, the apparatus includes a plurality of coupled pressure vessels, each having an inlet port to receive the pumpable substance, an outlet port to remove the pumpable substance, an isolator to pressurize the pumpable substance and a high-pressure port for receiving pressurizing fluid to bias the isolator toward the pumpable substance. The apparatus can further include blocking valves to limit the travel of materials that may leak through the inlet and outlet valves, a heat exchanger to heat and/or cool the pumpable substance, and/or a gas controller to add gas to the pumpable substance or remove gas from the pumpable substance. Cleaning, rinsing, and/or sanitizing fluid can be pumped through the entire system, including through the isolator to cleanse and/or sanitize.

### TECHNICAL FIELD

This invention relates to methods and apparatus for pressure processing a pumpable substance, for example, food substances and the like.

### BACKGROUND OF THE INVENTION

Flowable substances, such as liquid food products, may be treated by exposure to ultrahigh-pressures. For example, liquid food products may be preserved or otherwise chemically or physically altered after exposure to ultrahigh-pressures. In one conventional process, the food substance is loaded into a pressure vessel where it is pressurized to a selected pressure for a selected period of time to achieve the desired physical or chemical change. The vessel is then depressurized and the contents unloaded. The pressure vessel may then be reloaded with a new volume of unprocessed substance and the process may be repeated.

Although current systems produce desirable results, issues of product contamination can arise. Contamination is an important issue in certain applications, particularly those involving pressure-processing of food substances. Contamination can potentially result from contact between the food substance and the outside environment, or can potentially result from exposure of the pressure processed food product to the unprocessed food product.

### SUMMARY OF THE INVENTION

The invention relates to methods and apparatus for pressure-processing a pumpable substance, such as a food substance, in one or more pressure vessels. In one embodiment, the apparatus can include first and second high pressure vessels each having an inlet port, an outlet port and an isolator for isolating the pumpable substance from a repressurizing fluid. The pressure vessels are coupled to a controller to move the isolators according to a schedule such that the schedule for one isolator is delayed or offset relative to the schedule for the other isolator.

The apparatus can further include first and second spaced apart valves coupled to the inlet port and/or the outlet port and movable between an open position and a closed position. A detector between the two valves is positioned to detect leakage of the pumpable substance past one of the valves when the valve is in its closed position. The detector can include any suitable device, such as a pressure sensor or a pH sensor.

In another embodiment, the apparatus can include one or more devices coupled to the pressure vessels to further process the pumpable substance before and/or after it has been pressurized. For example, in one embodiment, the apparatus can include a heat exchanger coupled to the inlet port or the outlet port of one or more of the pressure vessels to transfer heat between the pumpable substance and the region external to the heat exchanger. In another embodiment, the apparatus can include a gas controller coupled to at least one of the inlet port and the outlet port for removing a gas from the pumpable substance.

In yet another embodiment of the invention, the isolator in the pressure vessel can include a piston with a channel extending therethrough. The channel can include a first opening in fluid communication with the inlet port and a second opening in fluid communication with a high pressure fluid port. The piston can further include a valve positioned between the first and second openings of the channel to regulate flow from one side of the piston to the other.

### BRIEF DESCRIPTION OF THE DRAWINGS

FIG. 1 is a partially broken, partial cross-sectional side elevation view of an apparatus having a pressure vessel with a pumpable substance valve, a high pressure valve and an isolator in accordance with an embodiment of the invention.

FIG. 2 is a partially schematic, detailed cross-sectional side elevation view of a portion of the vessel and the pumpable substance valve shown in FIG. 1.

FIG. 3 is a detailed cross-sectional side elevation view of the high pressure valve shown in FIG. 1.

FIG. 4 is a detailed cross-sectional side elevation view of the isolator shown in FIG. 1.

FIG. 5 is a schematic view of an apparatus having heat exchangers, gas controllers and three vessels of the type shown in FIG. 1, in accordance with another embodiment of the invention.

FIG. 6 is a cross-sectional side elevation view of an embodiment of the gas controller shown in FIG. 5.

### DETAILED DESCRIPTION OF THE INVENTION

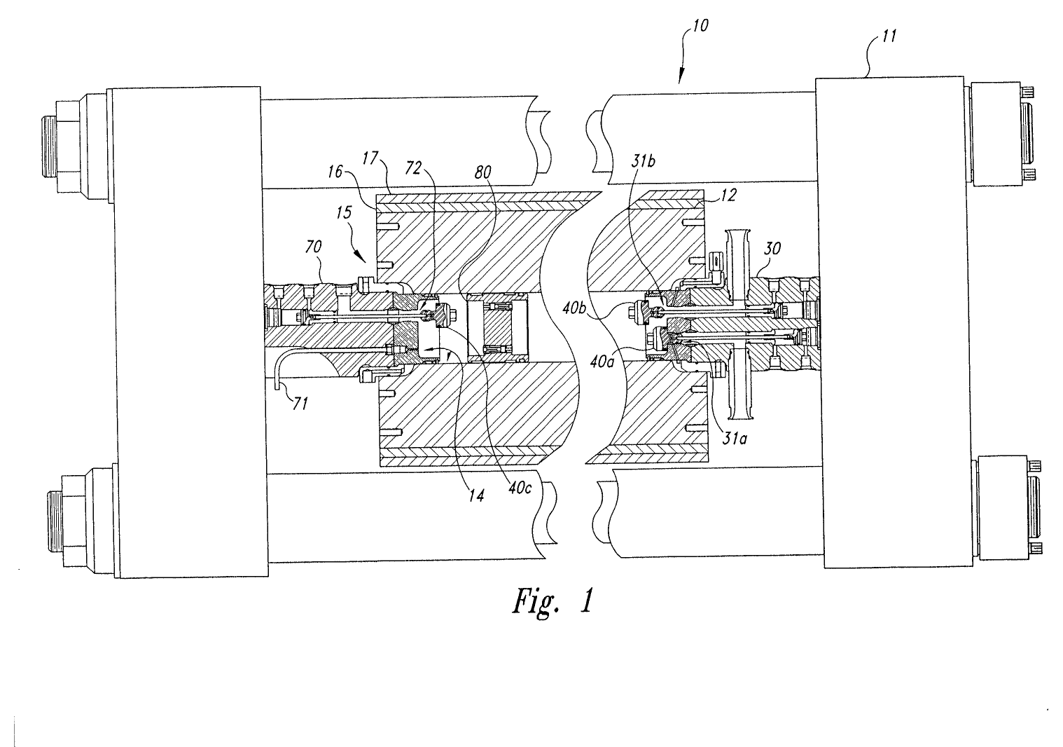

The present invention is directed toward methods and apparatus for pressure-processing pumpable substances, such as food products. Details of certain embodiments of the invention are set forth in the following description, and in FIGS. 1-6, to provide a thorough understanding of such embodiments. One skilled in the art, however, will understand that the present invention may have additional embodiments, and that they may be practiced without several of the details described in the following description.

A pressure processing apparatus in accordance with one embodiment of the invention includes a plurality of pressure vessels, each having an internal inlet valve that opens to admit a pumpable substance into the vessel. The inlet valve then closes and the pumpable substance is compressed by a piston that is driven by an ultrahigh-pressure fluid. After the pumpable substance has been pressurized, an internal outlet valve opens to remove the pressurized pumpable substance. The inlet and outlet valves can be supplied with a control fluid that can reduce the likelihood of contaminating the pressurized pumpable substance by creating a fluid barrier between the pressurized and unpressurized pumpable substances. Blocking valves adjacent the inlet and outlet valves can prevent the purging fluid from contaminating the pumpable substance, and can prevent the unpressurized pumpable substance from contaminating the pressurized pumpable substance.

FIG. 1 is a partial cross-sectional side elevation view of a pressure-processing apparatus 10 that includes a pressure vessel 15 having an internal surface 14 capable of withstanding high internal pressures. The pressure vessel 15 may include an open-ended cylinder 12 partially surrounded by an insulating layer 16 and a protective shield 17. The cylinder 12 can firther include a pumpable substance valve 30 at one end and a high pressure valve 70 at the opposite end. A yoke 11 secures the pumpable substance valve 30 and the high pressure valve 70 in place when the pressure vessel 15 is subjected to high internal pressures. The pumpable substance valve 30 includes two ports 31, shown in FIG. 1 as an inlet port 31a that admits unpressurized pumpable substance into the pressure vessel 15, and an outlet port 31b that evacuates the pumpable substance from the pressure vessel once the pumpable substance has been pressurized. Each of the ports 31 can be sealed and unsealed with a valve body 40 (shown as an inlet valve body 40a and an outlet valve body 40b).

The pumpable substance can be pressurized by an ultra high-pressure fluid that is separated from the pumpable substance by an isolator 80. In one embodiment, the isolator 80 can be a piston that is driven by the ultrahigh-pressure fluid to move axially within the pressure vessel 15. The ultrahigh-pressure fluid is supplied to the pressure vessel 15 through a high pressure conduit 71 in the high pressure valve 70. The ultrahigh-pressure fluid is initially removed from the pressure vessel 15 through the high pressure conduit 71 until the pressure within the vessel 15 is low enough to allow a low pressure port 72 to open by moving a low pressure valve body 40c. Once the low pressure port 72 is opened, the remaining ultra-high pressure fluid can be evacuated from the pressure vessel 15 at a higher rate of flow through the low pressure port.

In one embodiment, the apparatus 10 can include a model number 012122 assembly available from Flow International Corp. of Kent, Wash. that includes the vessel 15, yoke 11 and shield 17, configured to withstand an internal vessel pressure of at least 100,000 psi. In other embodiments, the apparatus 10 can include other pressure vessels 15 and peripheral components configured to withstand an internal pressure of 100,000 psi or another suitable pressure, depending upon the selected pumpable substance and treatment. Such vessels and components are available from ABB Pressure Systems of Vasteras, Sweden, Autoclave Engineering of Erie, Pa., or Engineered Pressure Systems of Andover, Mass.

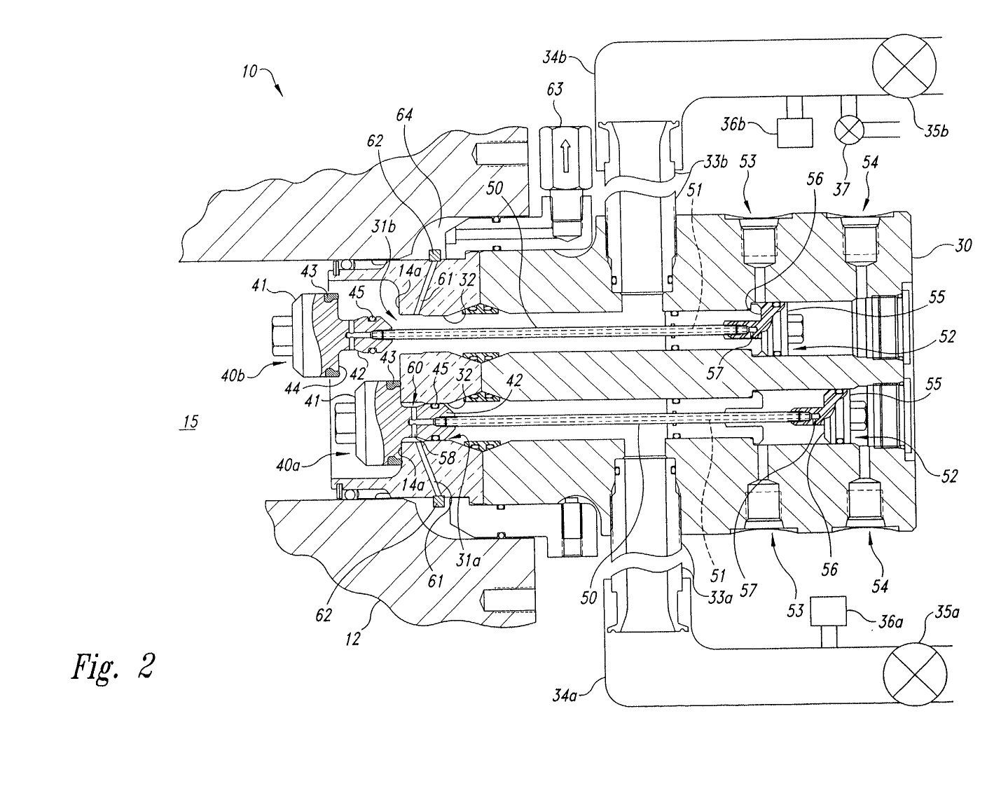

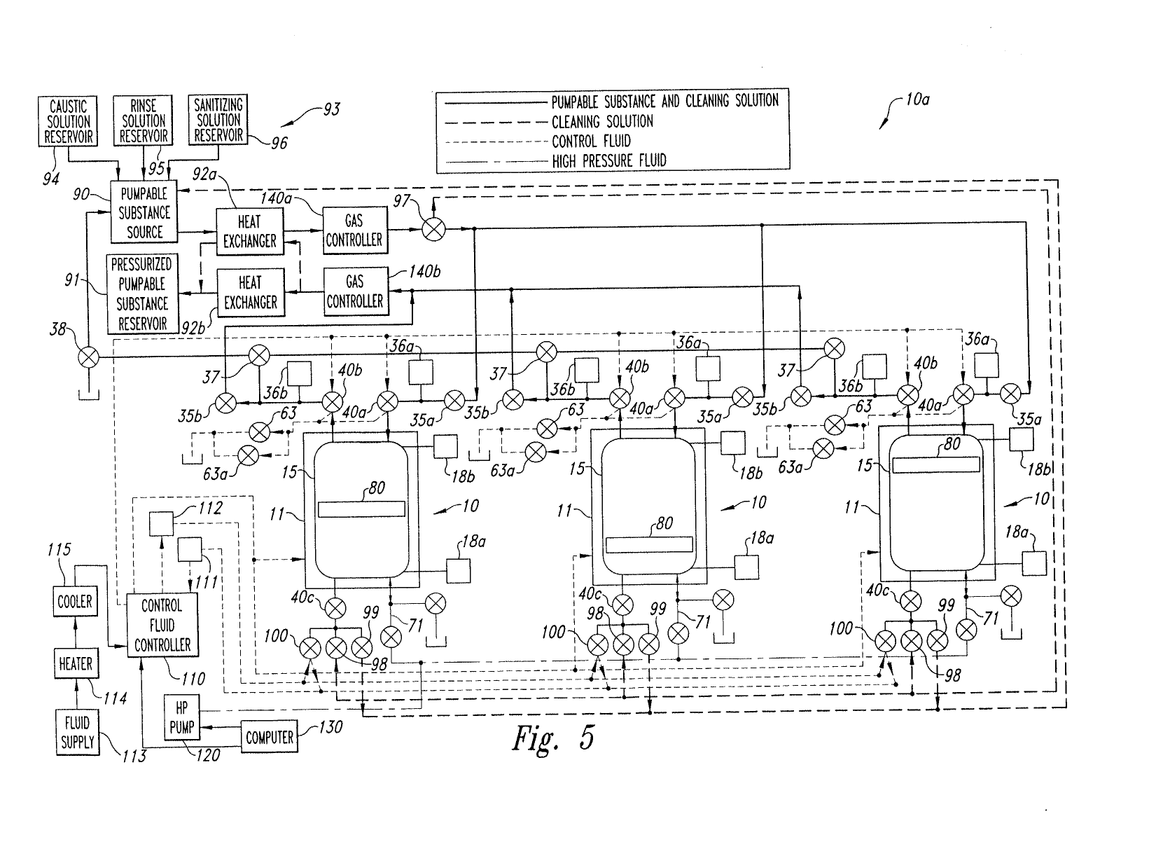

FIG. 2 is a detailed partial cross-sectional elevation view of the pumpable substance valve 30 and a portion of the cylinder 12 shown in FIG. 1. As shown in FIG. 2, the pumpable substance valve 30 can include an inlet coupling 33a in fluid communication with the inlet port 31a, and an outlet coupling 33b in fluid communication with the outlet port 31b. The inlet coupling 33a may be coupled to a source of pumpable substance (discussed in greater detail below with reference FIG. 5), to supply the pumpable substance to the pressure vessel 15. The outlet coupling 33b may be coupled to a container or a packaging device to package the pumpable substance once it has been pressure processed.

As mentioned above, the flow of the pumpable substance through the inlet port 31a and the outlet port 31b is controlled by the inlet valve body 40a and the outlet valve body 40b, respectively. Each valve body 40 is connected with a valve stem 50 to a valve piston 52 that drives the valve body 40 axially between an open position (shown by the position of the outlet valve body 40b in FIG. 2) and a closed position (shown by the position of the inlet valve body 40a in FIG. 2). Accordingly, each valve piston 52 has a forward face 55 adjacent an opening port 54 and a rear face 56 adjacent a closing port 53. When pressurized control fluid is forced through the opening port 54, it acts against the forward face 55 of the valve piston 52 to drive the valve body 40 axially to its open position. When the pressurized control fluid is forced through the closing port 53, it acts against the rear face 56 of the valve piston 52 to drive the valve body 40 axially to its closed position.

Each valve body 40 can include an external portion 41 that remains external to the corresponding port 31 when the valve body is in the closed position, and an internal portion 42 that extends into the port when the valve body is in the closed position. Each valve body 40 may also include one or more seals that restrict the motion of the pumpable substance past the valve body when the valve body is in the closed position. For example, the valve body 40 can include a flexible seal 43 around the periphery of the external portion 41. The flexible seal 43 can be held in place by a lip 44 so as to seal against an internal surface 14a of the pumpable substance valve 30 adjacent the corresponding port 31. The valve body 40 can also include an O-ring 45 around the internal portion 42 that seals against an internal surface 32 of the port 31.

An advantage of a valve body 40 having two seals (e.g., the flexible seal 43 and the O-ring 45) is that the seals reduce the likelihood that the pumpable substance will flow past the valve body when the valve body is in the closed position. For example, the two seals may reduce the likelihood that the pumpable substance will escape past the outlet valve body 40b and enter the outlet port 31b when the outlet valve body 40b is in the closed position and the pumpable substance is pressurized. Such a condition is undesirable because the escaping pumpable substance may not be fully pressure processed, and may therefore contaminate the fully processed substance that subsequently passes through the open outlet port 31b. Furthermore, the two seals on the inlet valve body 40a may prevent unpressurized pumpable substance from passing out of the inlet port 31 a and directly into the outlet port 3 lb without being pressurized, for example when the inlet valve body 40a is in the closed position and the outlet valve body 40b is in the open position.

The valve body 40 can also include a purging zone 60 that may further reduce the likelihood that the fully processed pumpable substance will be contaminated with unprocessed or under-processed pumpable substance. As shown in FIG. 2, the purging zone 60 can be positioned between the O-ring 45 and the flexible seal 43. The purging zone 60 can be further bounded by the internal portion 42 of the valve body 40 and by the inner surface 32 of the port 31. The control fluid can enter the purging zone 60 through one or more orifices 58 located in the valve body 40 adjacent the purging zone. The orifices can be coupled to a source of control fluid (discussed in greater detail below with reference to FIG. 5) via a passage 51 in the valve stem 50. Accordingly, the control fluid can enter the passage 51 via a passage entrance 57 when the valve body 40 is in the closed position and flow through the valve stem 50 to the purging zone 60. When the valve body 40 is in the open position, the valve piston 52 blocks the passage entrance 57, preventing the control fluid from entering the passage 51 and therefore preventing the control fluid from flowing freely into the pressure vessel 15.

While in the purging zone 60, the control fluid can entrain particles of unprocessed or under-processed pumpable substance that might enter the purging zone by escaping past the flexible seal 43 and/or the O-ring 45. Accordingly, the purging zone 60 forms a fluid barrier between a region containing fully processed pumpable substance and a region containing unprocessed or only partially processed pumpable substance. For example, the purging zone 60 surrounding the outlet valve body 40b may prevent pumpable substance that has not been fully pressure processed from escaping the pressure vessel 15 before the processing cycle is complete. Furthermore, the purging zone 60 surrounding the inlet valve body 40a may prevent unprocessed pumpable substance from flowing past the inlet valve body and out through the outlet port 3 lb when the outlet valve body 40b is opened to remove the pumpable substance from the vessel 15.

The control fluid can exit the purging zone 60 through an exit channel 61 to convey unpressurized or under-pressurized pumpable substance away from the corresponding port 31. The exit channel 61 can include a check valve 62 that prevents the control fluid from re-entering the purging zone 60 when the pressure in the purging zone drops. For example, the check valve 62 can include a flexible elastomeric ring that expands in diameter away from the exit channel 61 to allow the control fluid to escape, and collapses on the exit channel to prevent the control fluid from re-entering the purging zone 60. The escaping control fluid can pass into an annulus 64 and away from the pressure vessel 15 through a relief valve 63. The relief valve 63 can be adjusted to maintain a pressure in the annulus 64 that is low enough to allow the control fluid to escape and high enough to prevent the pumpable substance from passing out of the pressure vessel 15 between the cylinder 12 and the pumpable substance valve 30.

The control fluid may include any suitable fluid that can drive the valve bodies 40 back and forth and purge the pumpable substance from the purging zones 60. In one embodiment, the control fluid may also include a compound that contains iodine to clean and/or sanitize the surfaces adjacent the purging zone 60 as the control fluid passes through the purging zone 60. Alternatively, the control fluid may be selected to contain any substance that cleanses the purging zone 60 without adversely affecting the characteristics of the pumpable substance. Accordingly, the control fluid may further reduce the likelihood that the fully pressure processed pumpable substance is contaminated by under-pressurized or unpressurized pumpable substance. In addition, the control fluid may reduce the likelihood that particulates (which might be included in the pumpable substance) will become lodged between the valve body 40 and the port 31 where they can prevent the valve body from fully closing.

As is also shown in FIG. 2, the pumpable substance valve 30 can be coupled to pumpable substance conduits 34 (shown as an inlet conduit 34a coupled to the inlet coupling 33a and an outlet conduit 34b coupled to the outlet coupling 33b). Each conduit 34 can include a blocking valve 35 (shown as an inlet blocking valve 35a and an outlet blocking valve 35b) spaced apart from the corresponding valve body 40. Between each blocking valve 35 and the corresponding valve body 40 is positioned a detector 36 shown as an inlet detector 36a and an outlet detector 36b. If the pumpable substance inadvertently leaks past either valve body 40 when the valve body is in its closed position, the corresponding blocking valve 35 prevents the pumpable substance from passing any further in the corresponding conduit 34. Furthermore, the detector 36 can detect the presence of the leak by detecting a change in a characteristic of the pumpable substance in the conduit between the valve body 40 and the blocking valve 35. For example, the detector 36 can include a pressure transducer that detects an increase in pressure if the pumpable substance leaks past the valve body 40. In other embodiments, the detector 36 can include an opacity meter that detects a change in the color characteristics of the material in the conduit, or a pH detector that detects a change in the pH of the material in the conduit caused by leakage of the pumpable substance through the closed valve body 40. In still further embodiments, the detector 36 can include other devices capable of detecting the presence of a leak between the valve body 40 and the blocking valve 35.

The outlet conduit 34b can further include a diverter valve 37 positioned between the outlet blocking valve 35b and the outlet valve body 40b. In its closed position, the diverter valve 37b allows the pressurized pumpable substance to pass through the outlet conduit 34b and through the blocking valve 35b for packaging or other post-pressurization processing. In its open position, the diverter valve 37 can divert the pumpable substance either to a dump or back to the source of the unpressurized pumpable substance. Accordingly, in the event that the apparatus 10 pressurizes the pumpable substance by less than a selected amount, the diverter valve 37 can be moved to its open position to either dispose of the partially pressurized pumpable substance or return the pumpable substance to its source, from which it can be reintroduced to the cylinder 15 for further pressurization.

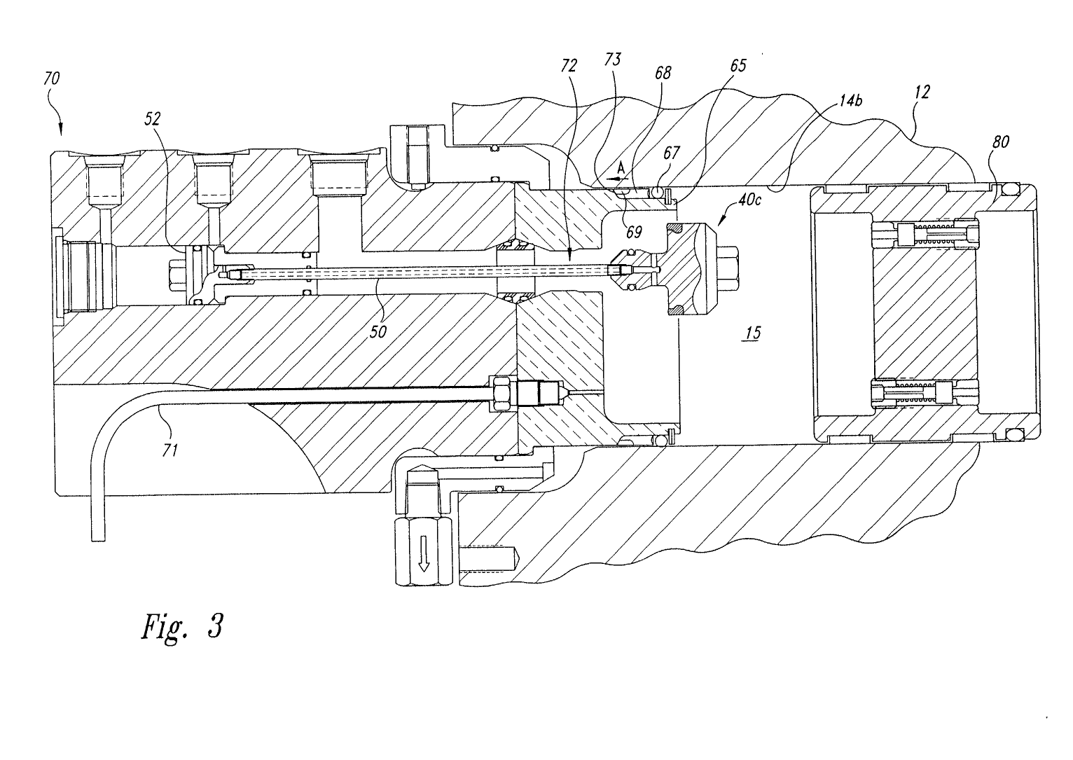

FIG. 3 is a detailed partial cross-sectional side elevation view of the high pressure valve 70 and the high pressure conduit 71 shown in FIG. 1. The high pressure conduit 71 can be coupled to a source of ultrahigh-pressure fluid to drive the isolator 80 in the pressure vessel 15. The ultrahigh-pressure fluid can be supplied by a device such as a model No. 25XQ 100 available from Flow International Corp. of Kent, Wash., which includes a 150 Hp motor driving four hydraulic intensifiers, each capable of pressurizing water to 100,000 psi at a rate of 0.9 gpm. Other devices capable of generating pressures higher or lower than this value may be suitable as well, so long as the pressure is sufficient to produce the desired effect on the pumpable substance.

The ultrahigh-pressure fluid is evacuated from the pressure vessel 15 through the low pressure port 72 as the pressure vessel is filled with the pumpable substance. The low pressure port 72 may be opened and closed with the low pressure valve body 40c in a manner similar to that discussed above with reference to the inlet and outlet valve bodies 40a and 40b shown in FIG. 2. In one embodiment, the low pressure valve body 40c, the valve stem 50, and the valve piston 52 shown in FIG. 3 may be identical to the valve bodies, valve stems and valve pistons shown in FIG. 2 to provide for commonality of parts. However, because the low pressure port 72 is not exposed to the pumpable substance, the high pressure valve 70 need not include a purging zone 60 (FIG. 2) or an exit channel 61 (FIG. 2).

As shown in FIG. 3, the high pressure valve 70 can include a sealing flange 65 that is sealably coupled to an internal surface 14b of the cylinder 12 to seal the high pressure valve 70 within the cylinder. The sealing flange 65 is spaced apart from the internal surface 14b to accommodate an O-ring 67 that sealably engages both the internal surface 14b and the flange 65. The high pressure valve 70 can also include an elastomeric seal 68 adjacent the O-ring, and an anti-extrusion ring 69 adjacent the elastomeric seal, both of which are seated against an aft surface 73 of the sealing flange 65. The elastomeric seal 68 may comprise a polymer, such as an ultra-high molecular weight polyethylene, and the anti-extrusion ring 69 may include a metal, such as bronze. The aft surface 73 of the sealing flange 65 may be inclined so that as the elastomeric seal 68 is forced aft in the direction indicated by arrow A (for example, when the pressure vessel 15 is pressurized), the elastomeric seal 68 forces the anti-extrusion ring 69 outward toward the cylinder 12, to prevent the elastomeric seal 68 from extruding into a small gap that might exist between the high pressure valve 70 and the cylinder 12. This arrangement may be advantageous because it reduces wear on the elastomeric seal 68. A similar arrangement may be used to seal the pumpable substance valve 30 (FIG. 2) to the cylinder 12.

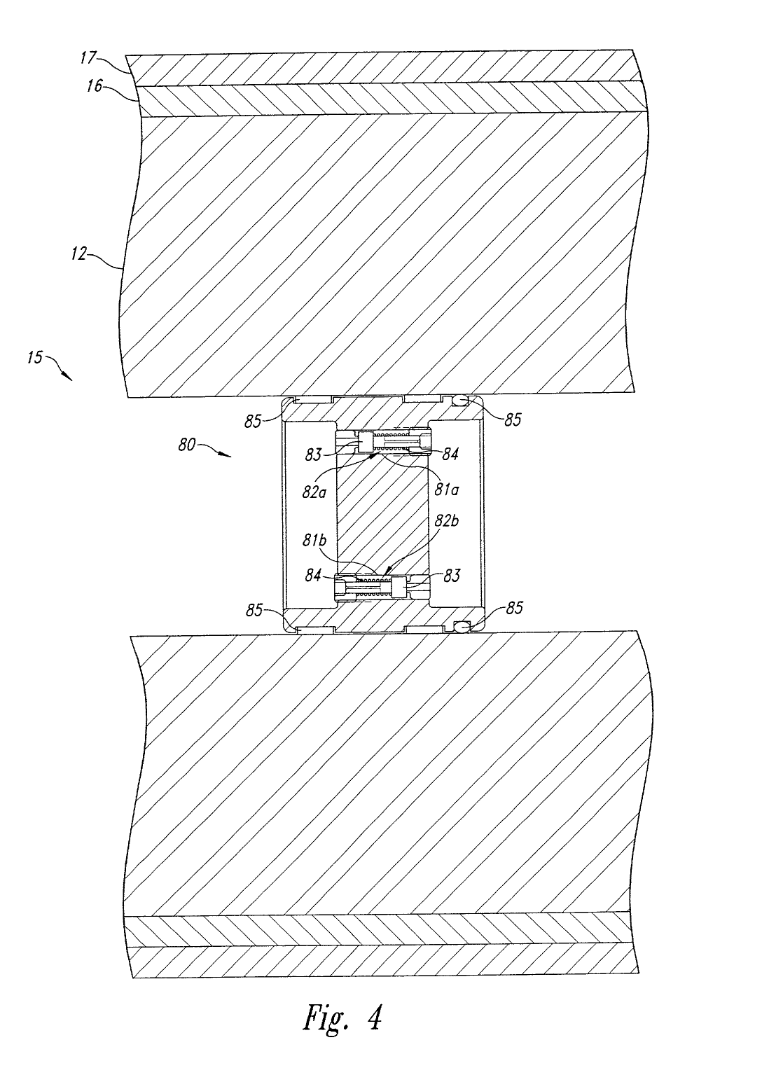

FIG. 4 is a detailed cross-sectional side elevation view of a portion of the pressure vessel 15 and the isolator 80 shown in FIG. 1. The isolator 80 can be in the form of a piston having seals 85 that slideably and sealably engage the inner wall of the cylinder 12. The isolator 80 can further include flow passages 81 (shown as an upper flow passage 81a and a lower flow passage 81b). Each flow passage 81 can include a relief valve 82 (shown as an upper relief valve 82a and a lower relief valve 82b). The relief valves 82 include stoppers 83 that are biased to a closed position by a biasing device 84, such as a spring.

In a preferred embodiment, each of the check valves 82 allows flow to pass in the direction opposite of the other check valve. For example, as shown in FIG. 4, the upper relief valve 82a allows flow to pass from the left side of the isolator 80 to the right side of the isolator 80 when the difference in pressure between the left side of the isolator 80 and the right side of the isolator 80 exceeds a certain value. Similarly, the lower relief valve 82b can allow fluid to pass through the isolator 80 from the right side of the isolator to the left side of the isolator when the pressure differential across the isolator 80 from right to left exceeds a selected value. In one embodiment, the isolator 80 can include two flow passages 81, as shown in FIG. 4, and in other embodiments, the isolator 80 can include more than two flow passages, so long as the structural integrity of the isolator 80 is maintained. In yet another embodiment, the isolator can include a single flow passage 81 having a single relief valve 82 for passage of fluids in only one direction.

The flow passages 81 and check valves 82 in the isolator 80 can perform a variety of functions. For example, when the pressure vessel 15 is cleaned, the isolator 80 can be moved to the extreme right side of the cylinder 12 against the pumpable substance valve 30 (FIG. 1). Fluid at high pressure can then be pumped through the upper relief valve 82a and into a region between the isolator 80 and the pumpable substance valve 30 for cleaning this region. Similarly, the isolator 80 can be driven to the left end of the cylinder 12 against the high pressure valve 70 (FIG. 1) and cleaning fluid can be forced through the lower passage 81b and lower relief valve 82b to clean the region between the isolator 80 and the high pressure valve 70. In another procedure, the flow passages 81 and relief valves 82 can be used to relieve pressure which may build up during the course of operating the pressure vessel 15. In yet another procedure, the isolator 80 can be moved back and forth within the cylinder 12 to clean the cylinder without fluid passing through the flow passages 81. For example, the isolator 80 can scrub the walls of the cylinder 12 by pressurizing the isolator 80 with a cleaning fluid. The isolator 80 moves back and forth within the cylinder 12, the isolator 80 transports the cleaning fluid along the walls of the cylinder 12, while at the same time providing a mechanical scrubbing action as the seals 85 slide along the walls. 5 Operation of an embodiment of the apparatus 10 is best understood with reference to FIGS. 1 and 2. Beginning with FIG. 2, the outlet valve body 40b is closed by supplying control fluid through the corresponding closing port 53. The control fluid acts against the rear face 56 of the corresponding valve piston 52 to draw the outlet valve body 40b into the outlet port 3 lb. The O-ring 45 seals against the internal surface 32 of the port 31 and the flexible seal 43 seals against the internal surface 14a of the pumpable substance valve 30. The control fluid enters the purging zone 60 of the outlet valve body 40b through the corresponding control fluid passage 51, and exits the purging zone through the corresponding exit channel 61. The control fluid continues to flow as long as the outlet valve body is in the closed position. The outlet blocking valve 35b is also closed. The inlet blocking valve 35a is opened and the inlet valve body 40a is then moved to its open position by applying control fluid to the corresponding opening port 54. The control fluid acts against the forward face 55 of the corresponding valve piston 52 to drive the inlet body 40a to the open position.

Referring now to FIG. 1, the low pressure valve body 40c is moved to its open position in a manner similar to that discussed above with reference to the inlet valve body 40a. The pumpable substance is then introduced through the inlet port 31 a and into the pressure vessel 15 to move the isolator 80 toward the high pressure valve 70, driving residual high pressure fluid located between the isolator 80 and the high pressure valve 70 out through the low pressure port 72. The low pressure valve 40c, the inlet valve body 40a and the inlet blocking valve 35a are then closed and the ultrahigh-pressure fluid is introduced to the pressure vessel 15 through the high pressure conduit 71. The ultrahigh-pressure fluid drives the isolator 80 toward the pumpable substance valve 30 to compress the pumpable substance within the vessel. When the desired pressure is obtained, the flow of ultrahigh-pressure fluid is halted and the pumpable substance is allowed to remain at an elevated pressure for a selected period of time. If, during this time, either detector 36 detects a pressure leak, the process can be halted and the partially pressurized pumpable substance can either be disposed of or reintroduced to the pressure vessel 15.

When the selected period of time has elapsed, the pressure within the pressure vessel 15 is relieved by initially passing the ultra-high pressure fluid out of the pressure vessel 15 through the high pressure conduit 71. The outlet blocking valve 35b and the valve bodies 40b and 40c are then opened and low pressure fluid is supplied through the low pressure port 72 to move the isolator 80 toward the outlet valve body 40b and remove the pumpable substance from the pressure vessel 15 through the outlet port 3 lb. The cycle can then be repeated with a new quantity of pumpable substance.

One advantage of an embodiment of the apparatus 10 shown in FIGS. 1-4 is that the blocking valves 35 restrict the motion of pumpable substance which may inadvertently leak past the valve bodies 40. In addition, the detectors 36 can detect the presence of such a leak.

Another advantage is that the plurality of seals on each valve body 40 reduces the likelihood that the valve body will leak and contaminate pressure processed pumpable substance with unpressurized or under-pressurized pumpable substance. Yet another advantage is that the two seals may define a purging zone 60 between the fully pressurized pumpable substance and the unpressurized pumpable substance. A control fluid may be passed through the purging zone 60 to remove under-pressurized pumpable substance from the purging zone, creating a fluid barrier between the pressurized pumpable substance and the unpressurized or under-pressurized pumpable substance. Furthermore, the control fluid may sanitize the surfaces of the apparatus in the purging zone. Both the purging function and the sanitizing function can be completed while the apparatus is pressurized and without having to access the interior of the pressure vessel 15.

Still another advantage of the apparatus 10 shown in FIGS. 1-4 is that the seal 68 between the cylinder 12 and the valves 30 and 70 may include an anti-extrusion ring 69 positioned adjacent an inclined surface of the valves. The anti-extrusion ring 69 moves outward under pressure to reduce wear on the seal and to reduce the likelihood of a leak developing between the cylinder 12 and the valves 30 and 70.

FIG. 5 is a schematic view of a semicontinuous processing apparatus 10a that includes three coupled apparatus 10, such as are shown in FIG. 1. Accordingly, each apparatus 10 includes a pressure vessel 15 surrounded by a yoke 11 and each pressure vessel 15 includes a movable isolator 80, an inlet valve body 40a, an outlet valve body 40b, a low pressure valve body 40a, and a high pressure conduit 71, as was discussed above with reference to FIGS. 1-4. As will be discussed in greater detail below, the motion of the valves and isolators is controlled by a computer 130 so that each apparatus 10 operates according to a schedule (such as was discussed above with reference to FIGS. 1-4) that is offset or staggered from the schedule of the other apparatus 10. Accordingly, the semicontinuous processing apparatus 10a can operate in the manner of a multi-cylinder internal combustion engine to produce a semicontinuous flow of pressurized pumpable substance. In the embodiment shown in FIG. 5, the apparatus 10a includes three pressure vessels 15, and in other embodiments the apparatus 10a can include more or fewer pressure vessels 15 (for example, one pressure vessel 15), to produce a semicontinuous flow of pressurized pumpable substance.

The apparatus 10a includes a pumpable substance source 90 for supplying the pumpable substance to each of the three pressure vessels 15. The pumpable substance can include an abrasive slurry, a food stuff, such as juice, partially liquefied fruits or vegetables, or any substance that can be pumped through the devices included in the apparatus 10a. For purposes of clarity, the path followed by the pumpable substance is shown in heavy solid lines in FIG. 5, while the paths followed by the control fluid and high pressure fluid are shown in dashed and phantom lines, respectively. Cleaning solutions follow the path of the pumpable substance shown in heavy solid lines as well as the path shown in heavy dashed lines.

The pumpable substance can pass from the source 90 to a pre-processing heat exchanger 92a for heating the pumpable substance. It may be advantageous to heat the pumpable substance before pressurization for a variety of reasons. For example, heating the pumpable substance may, in conjunction with pressurization, reduce or eliminate microorganisms in the pumpable substance. In one aspect of this embodiment, the pressure to which the pumpable substance is subjected and/or the time during which the pumpable substance remains under pressure can be reduced by heating the pumpable substance in the heat exchanger 92a prior to pressurization. In another embodiment, the heat exchanger 92a can be used to cool the pumpable substance for a beneficial effect with certain food items. In either case, the heat exchanger 92a can be a scrape surface heat exchanger (to prevent the pumpable substance from adhering to the walls of the heat exchanger where it may bum), such as a model number 4X120 available from Cherry-Burrel of Little Falls, N.Y., or another suitable device having a channel for receiving the pumpable substance and a heat exchanger surface for transferring heat to and/or from the pumpable substance.

From the heat exchanger 92a, the pumpable substance can pass to a gas controller 140a. In one embodiment, the gas controller 140a can include a de-aerator that removes air or other gasses from the pumpable substance prior to pressurization, such as a model number 16 available from Aro-Vac (Division of Cherry Burrell) of Little Falls, N.Y. It may be advantageous to remove air and other gasses from the pumpable substance to prevent hydrocarbons present in the food from detonating under pressure, which may, in turn, cause the food to bum and thereby reduce the quality of the food. In one embodiment, the gas controller 140a is positioned downstream of the heat exchanger 92a because the pumpable substance is more likely to out-gas after it has been heated.

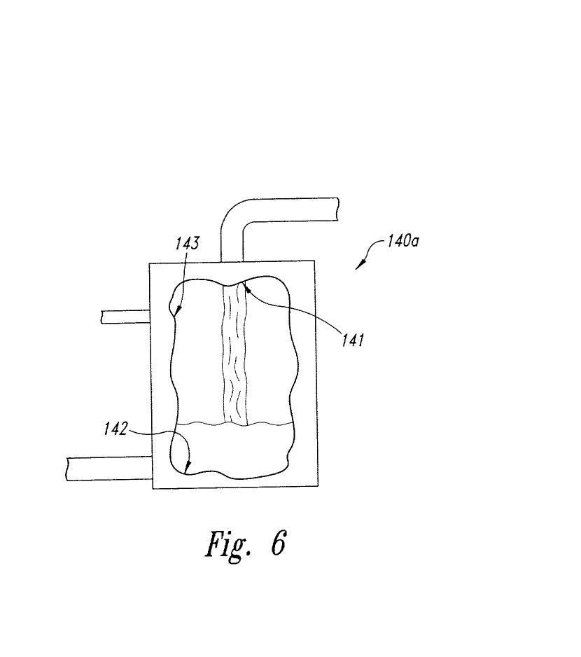

In one embodiment, the gas controller 140a can include a gravity fed device, such as is shown in FIG. 6. The gas controller 140a accordingly includes an entrance port 141 positioned above an exit port 142. A vacuum port 143 is positioned between the entrance port 141 and the exit port 142 and is coupled to a vacuum source (not shown). In operation, the pumpable substance enters the gas controller 140a through the entrance port 141 and as the pumpable substance descends toward the exit port 142, air or other gasses are extracted from the pumpable substance and passed through the vacuum port 143.

Returning to FIG. 5, the gas controller 140a can also be operated to introduce a gas to the flow of pumpable substance. For example, in one embodiment, the gas controller 140a can introduce carbon dioxide to the pumpable substance which can reduce the amount of bacteria therein. In other embodiments, other gasses can be added to the pumpable substance to produce the same or other beneficial effects.

The pumpable substance is pumped from the gas controller 140a through a cleaning solution valve 97 (discussed in greater detail below) to each of the three pressure vessels 15, where it is processed according to the steps discussed above with reference to FIGS. 1-4. The pressurized pumpable substance is then removed from the pressure vessels 15 through the outlet valves 40b from which it can pass to a post-processing gas controller 140b. The post-processing gas controller 140b can be used to remove gas from the pressurized pumpable substance. For example, if carbon dioxide was added to the pumpable substance before pressurization, the post-processing gas controller 140b can be used to remove the carbon dioxide once pressurization has been completed.

From the post-processing gas controller 140b, the pressurized pumpable substance can pass to a post-processing heat exchanger 92b. In one aspect of this embodiment, the post-processing heat exchanger 92b and the heat exchanger 92a can be coupled in the manner of a regenerative heat exchanger such that the heat extracted from the pressurized pumpable substance in the post-processing heat exchanger 92b is used to increase the temperature of the unpressurized pumpable substance in the heat exchanger 92a. The pressurized pumpable substance then passes to a pressurized pumpable substance reservoir 91 where the pressurized pumpable substance can be packaged or otherwise prepared for end use.

If, for any reason, the pressurized pumpable substance is not to be delivered to the reservoir 91, the valves 37 can be adjusted to divert the pressurized pumpable substance away from the reservoir 91. A dump valve 38 can then be selectively positioned to dump the pressurized pumpable substance or return the pressurized pumpable substance to the pumpable substance source 90 for repressurization.

In a preferred embodiment, a cleaning system 93 is coupled to the pumpable substance source 90 for cleaning the pumpable substance source 90, the vessels 15, and the pressurized pumpable substance reservoir 91, as well as the intermediate devices and connecting hardware. In one aspect of this embodiment, the cleaning system 93 can include a caustic solution reservoir 94 (containing a fluid such as citric acid or acidified water), a rinse solution reservoir 95 (containing rinse liquids, such as water), and a sanitizing resolution reservoir 96 (containing sanitizing fluid, such as those available from Echo Labs of Portland, Oreg.). The solutions contained in each of the reservoirs 94-96 can be sequentially pumped through the apparatus 10a to both clean and sanitize the apparatus. For example, each of the solutions can be pumped through the pumpable substance source 90, the heat exchanger 92a, the gas controller 140a and into the cleaning solution valve 97.

During cleaning, the cleaning solution valve 97, which normally directs the pumpable substance past the inlet valve bodies 40a and into the upper portion of each of the vessels 15, can be positioned to direct the cleaning solutions into both the upper portions of each vessel 15, and via a cleaning inlet valve 98, into the lower portion of each pressure vessel 15. Accordingly, the cleaning solutions can be used to clean the pressure vessel 15 both above and below the isolator 80. The cleaning solution in the upper portion of each pressure vessel 15 then flows past the outlet valve body 40b through the post-processing gas controller 140b, the post-processing heat exchanger 92b, and into the pressurized pumpable substance reservoir 91 to clean these components and connecting hardware. The cleaning solution in the lower portions of the pressure vessels 15 can be returned to the pumpable substance source 90 via a cleaning outlet valve 99 positioned at the bottom of each pressure vessel 15.

The apparatus 10a can further include a control fluid controller 110 that supplies and regulates the flow of control fluid to several of the valves of the apparatus. As was discussed above with reference to FIGS. 1-4, the control fluid can be used to clean the valves and provide a fluid barrier between pressurized and unpressurized portions of the pumpable substance. As will be discussed in greater detail below, the control fluid can also be used to diagnose the operation of the pressure vessels 15.

The control fluid controller 110 can be coupled to a fluid supply 113 that supplies a suitable fluid for operating and cleaning the valves of the apparatus 10a. In one embodiment, the fluid supply can supply citric acid or another liquid having a non-zero pH, and in other embodiments, other suitable fluids can be used. The fluid supply 113 can be filled with such cleaning solutions before initial startup of the apparatus 10a and/or at selected intervals after initial startup. In one embodiment, the fluid supply 113 can be sequentially filled with a caustic solution, a rinse solution and a sanitizing solution to clean the components powered by the control fluid in a manner similar to that discussed above with reference to the cleaning system 93.

The control fluid passes from the fluid supply 113 to a heater 114 for sterilizing the control fluid, and then to a cooler 115 to cool the control fluid to a suitable operating temperature. From there, the control fluid controller 110 directs the control fluid to various portions of the apparatus 10a. For example, the control fluid can be directed to the yoke 11 of each pressure vessel 15 to control opening and closing of the yoke for access to the pressure vessel 15. The control fluid can also be directed to the inlet valve body 40a and the outlet valve body 40b to power these valves in the manner described above with reference to FIGS. 1-3. As was discussed above with reference to FIG. 2, the relief valve 63 can be coupled to the outlet valve body 40b to regulate the flow of the control fluid through the outlet valve body 40b. In one embodiment, a bypass valve 63a can be positioned to bypass the relief valve 63 so that the control fluid can be run at low pressure through the valve body 40b and up to the relief valve 63 for cleaning.

The control fluid can control the low pressure valve body 40c (as discussed above with reference to FIGS. 2 and 3), and can also drive the isolators 80 at low pressures, for example, to fill and empty the pressure vessels 15. Accordingly, the low pressure valve body 40c can be coupled to a selector valve 100 that can be moved to a first position which allows the control fluid to enter the pressure vessel 15 (for purging the pumpable substance after pressurization has been completed), and can be moved to a second position which allows the control fluid to drain from the pressure vessel 15 (for filling the pressure vessel 15 with the pumpable substance ).

In one embodiment, the pressure vessel 15 can include two detectors 18 (shown as a lower detector 18a below the isolator 80 and an upper detector 18 to above the isolator 80) to detect an inadvertent leak of the control fluid into the pressure vessel 15. As discussed above with reference to the detectors 36 shown in FIG. 2, the detectors 18 can include pressure sensors, pH sensors, opacity sensors and/or any sensor configured to detect a leak of the control fluid into the pressure vessel 15.

In one embodiment, the control fluid entering each pressure vessel 15 as the pumpable substance is purged from the vessel can pass through a purge flowmeter 112. The purge flowmeter 112 can detect the rate at which the control fluid enters each pressure vessel 15, as well as the total amount of control fluid entering each pressure vessel 15 Accordingly, the purge flowmeter 112 can be used as a diagnostic tool to determine whether each pressure vessel 15 is filling at the desired rate and/or when the pressure vessel 15 has been completely filled. Similarly, the control fluid leaving each pressure vessel 15 during the fill cycle can pass through a fill flowmeter 111 which, in a similar manner to that discussed above, can be used to determine the rate and/or total volume of pressurized substance entering the pressure vessel 15.

As was discussed above, the isolator 80 can be driven by a high pressure pump 120 during the pressurization step of the pressurizing process. The high pressure pump 120, the control fluid controller 110, and the other components that control the motion of the pumpable substance, the control fluid, and the cleaning fluids can be controlled by the computer 130. For purposes of clarity, only the connections between the computer 130 and the high pressure pump 120 and the control fluid controller 110 are shown in FIG. 5. The computer 130 can include a conventional personal computer coupled to a programmable logic controller, both of which are programmed to operate the apparatus 10a in an automatic, or semi-automatic mode, and to display and print out diagnostic or summary information related to the processing steps carried out by the apparatus 10a.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An apparatus for pressure processing a pumpable substance, comprising:
first and second generally rigid high pressure vessels each configured to withstand an internal pressure of up to at least approximately 100,000 psi, each vessel having an inlet port and an outlet port, each vessel having a isolator therein for isolating the pumpable substance from a pressurized fluid, the pressure vessels being coupled to a controller for moving the isolators according to a schedule with the schedule for one isolator being delayed relative to the schedule for the other isolator; and
a heat exchanger coupled to the at least one of the inlet port and the outlet port of one of the pressure vessels, the heat exchanger having a heat exchanger surface for transferring heat between the pumpable substance and a region external to the heat exchanger.

2. The apparatus of claim 1 wherein the heat exchanger is a first heat exchanger and is coupled to the inlet port of the first pressure vessel, further comprising a second heat exchanger coupled to the outlet port of the first pressure vessel.

3. The apparatus of claim 1 wherein the first and second heat exchangers are coupled to each other to transfer heat between the heat exchangers.

4. The apparatus of claim 1, further comprising an insulating material at least proximate to an outer surface of at least one of the vessels to reduce heat transfer between the one vessel and a region exterior to the one vessel.

5. The apparatus of claim 1, further comprising a source of the pumpable substance coupled to the inlet port of at least one of the vessels.

6. The apparatus of claim 5, further comprising the pumpable substance, the pumpable substance being selected from an abrasive slurry and a food.

7. An apparatus for ultra-high pressure processing a pumpable substance, the apparatus comprising:
first and second generally rigid high pressure vessels each configured to withstand an internal pressure of up to at least approximately 100,000 psi, each vessel having an inlet port and an outlet port, each vessel further having a isolator therein for isolating the pumpable substance from a pressurized fluid within the vessel;
a controller operatively coupled to the first and second vessels for moving the isolators according to a schedule with the schedule for the isolator of the first vessel being offset relative to the schedule for the isolator of the second vessel; and
a gas controller coupled to at least one of the inlet port and the outlet port of the first vessel for controlling an amount of gas added to or removed from the pumpable substance.

8. The apparatus of claim 7 wherein the gas controller includes a de-aerator for removing gas from the pumpable substance.

9. The apparatus of claim 8 wherein the de-aerator includes a chamber having an inlet aperture, an outlet aperture below the inlet aperture and a vacuum source coupled to the chamber between the inlet aperture and the outlet aperture for removing gas from the pumpable substance as the pumpable substance passes from the inlet aperture to the outlet aperture.

10. The apparatus of claim 7 wherein the gas controller is a first gas controller coupled to the inlet port of the first vessel to remove gas from a first portion of the pumpable substance entering the first vessel, further comprising a second gas controller coupled to the outlet port of the first vessel to remove gas from a second portion of the pumpable substance exiting the first vessel.

11. An apparatus for ultra-high pressure processing a pumpable substance, the apparatus comprising:
a pressure vessel having an inlet port for receiving a pumpable substance and an outlet port for exiting the pumpable substance;
a first valve coupled to one of the inlet port and the outlet port and movable between an open position and a closed position;
a flow channel in fluid communication with the first valve;
a second valve coupled to the flow channel, the second valve having an open position and a closed position, at least a portion of the second valve being spaced apart from a portion of the first valve to define an intermediate portion of the flow channel between the valves, the second valve being configured to seal the intermediate portion of the flow channel; and
a detector in fluid communication with the intermediate portion of the flow channel for detecting passage of the pumpable substance past one of the first and second valves into the intermediate portion when the one valve is in its closed position.

12. The apparatus of claim 11 wherein the pressure vessel is configured to withstand an internal pressure of at least approximately 100,000 psi.

13. The apparatus of claim 11 wherein the first valve is configured to withstand an internal pressure of at least approximately 100,000 psi.

14. The apparatus of claim 11 wherein the first valve includes at least one valve body disposed in one of the ports and movable relative to the port between an open position and a closed position, the valve body having a first seal that sealably engages the internal surface of the pressure vessel adjacent the port when the valve body is in the closed position and a second seal that sealably engages an inner surface of the port when the valve body is in the closed position, the first seal being disengaged from the internal surface of the pressure vessel when the valve body is in the open position, the second seal being disengaged from the inner surface of the port when the valve body is in the open position.

15. The apparatus of claim 14, further comprising a valve piston coupled to the valve body and having a first face and a second face facing away from the first face, the first face being in fluid communication with a source of pressurized fluid to move the valve body to the open position, the second face being in fluid communication with the source of pressurized fluid to move the valve body to the closed position.

16. The apparatus of claim 15 wherein the valve body has a channel therethrough with first and second spaced apart openings, the first opening being coupled to a source of sanitizing fluid to provide sanitizing fluid to a region of the valve body adjacent the second opening.

17. The apparatus of claim 11 wherein the detector includes a pressure detector for detecting an increase in pressure in the intermediate portion of the flow channel when the pumpable substance passes past one of the first and second valves when the one valve is in its closed position.

18. The apparatus of claim 11 wherein the detector includes a pH detector.

19. An apparatus for detecting flow of a pumpable substance toward or away from a vessel having an inlet port and an outlet port, the vessel being configured to ultra-high pressure process the pumpable substance, the apparatus comprising:
a first valve coupled to one of the inlet port and the outlet port and movable between an open position and a closed position;
a flow channel in fluid communication with the first valve;
a second valve coupled to the flow channel, the second valve having an open position and a closed position, at least a portion of the second valve being spaced apart from a portion of the first valve to define an intermediate portion of the flow channel between the valves, the second valve being configured to seal the intermediate portion of the flow channel; and
a detector in fluid communication with the intermediate portion of the flow channel for detecting passage of the pumpable substance past one of the first and second valves into the intermediate portion when the one valve is in its closed position.

20. The apparatus of claim 19 wherein the pressure vessel and the first valve are configured to withstand an internal pressure of at least approximately 100,000 psi.

21. The apparatus of claim 19 wherein the first valve includes at least one valve body disposed in one of the ports and movable relative to the port between an open position and a closed position, the valve body having a first seal that sealably engages the internal surface of the pressure vessel adjacent the port when the valve body is in the closed position and a second seal that sealably engages an inner surface of the port when the valve body is in the closed position, the first seal being disengaged from the internal surface of the pressure vessel when the valve body is in the open position, the second seal being disengaged from the inner surface of the port when the valve body is in the open position.

22. The apparatus of claim 21, further comprising a valve piston coupled to the valve body and having a first face and a second face facing away from the first face, the first face being in fluid communication with a source of pressurized fluid to move the valve body to the open position, the second face being in fluid communication with the source of pressurized fluid to move the valve body to the closed position.

23. The apparatus of claim 22 wherein the valve body has a channel therethrough with first and second spaced apart openings, the first opening being coupled to a source of sanitizing fluid to provide sanitizing fluid to a region of the valve body adjacent the second opening.

24. The apparatus of claim 19 wherein the detector includes a pressure detector for detecting an increase in pressure in the intermediate portion of the flow channel when the pumpable substance passes past one of the first and second valves when the one valve is in its closed position.

25. The apparatus of claim 19 wherein the detector includes a pH detector.

26. An apparatus for pressure processing a pumpable substance, comprising:
a pressure vessel having a first port for receiving the pumpable substance and a second port for receiving a high pressure fluid;
an isolator positioned within the pressure vessel between the first and second ports, the isolator having a channel extending therethrough, the channel having a first opening in fluid communication with the first port and a second opening in fluid communication with the second port; and
a valve in fluid communication with the channel and positioned between the first and second openings of the channel for selectively restricting flow between the first and second openings.

27. The apparatus of claim 26 wherein the pressure vessel is configured to withstand an internal pressure of up to at least 100,000 psi.

28. The apparatus of claim 26 wherein the valve includes a one-way relief valve configured to allow fluid to pass from the first opening through the channel to the second opening when a pressure of the fluid at the first opening exceeds a selected pressure.

29. The apparatus of claim 28 wherein the channel is a first channel and the valve is a first valve, the isolator having a second channel with a first opening in fluid communication with the first port and a second opening in fluid communication with the second port, the isolator further having a second valve in fluid communication with the second channel, the second valve including a one-way relief valve configured to allow fluid to pass from the second opening of the second channel through the second channel to the first opening of the second channel when a pressure of the fluid at the second opening of the second channel exceeds a selected value.

30. The apparatus of claim 26 wherein the isolator includes a piston.

31. An apparatus for pressurizing a pumpable substance, comprising:
pressure vessel having a first port for receiving the pumpable substance and a second port for receiving a pressurized fluid;
an isolator positioned within the pressure vessel between the first and second ports, the isolator being movable within the vessel to pressurize the pumpable substance; and
a source of the high pressure fluid coupled to the second port of the pressure vessel for moving the isolator within the vessel, the source having a high pressure fluid selected from liquids having a non-zero pH.

32. The apparatus of claim 31 wherein the fluid includes citric acid.

33. The apparatus of claim 31 wherein the isolator includes a piston that sealably and slideably engages a wall of the vessel.

34. The apparatus of claim 33 wherein the piston has a channel extending therethrough, the channel having a first opening in fluid communication with the first port and a second opening in fluid communication with the second port.

35. An apparatus for pressure processing a pumpable substance, comprising:
first and second generally rigid high pressure vessels each configured to withstand an internal pressure of up to at least approximately 100,000 psi, each vessel having an inlet port and an outlet port, each vessel having an isolator therein for isolating the pumpable substance from a pressurized fluid, the pressure vessels being coupled to a controller for moving the isolators according to a schedule with the schedule for one isolator being delayed relative to the schedule for the other isolator, each isolator having a channel extending therethrough to allow fluid to selectively pass from one side of the isolator to the other, each channel having a valve to regulate a flow of fluid through the channel;
a heat exchanger coupled to the at least one of the inlet port and the outlet port of one of the vessels, the heat exchanger having a heat exchanger surface for transferring heat between the pumpable substance and a region external to the heat exchanger;
a gas controller coupled to at least one of the ports of at least one of the vessels for controlling a flow of gas added to or removed from the pumpable substance; and
first and second spaced apart valves coupled to at least one of the inlet port and the outlet port of each vessel, the first and second valves each having an open position and a closed position and being coupled by a conduit having a detector for detecting the passage of pumpable substance into the conduit when both the first and second valves are in their closed positions.

36. A method for pressure processing a pumpable substance, comprising:
heating first and second portions of the pumpable substance;
transferring the first portion of the pumpable substance directly to a first high pressure vessel;
transferring the second portion of the pumpable substance directly to a second high pressure vessel and operatively coupling the first and second vessels;
pressurizing the first portion of the pumpable substance in the first high pressure vessel according to a first schedule and pressurizing the second portion of the pumpable substance in the second vessel according to a second schedule with the first and second schedules offset from each other; and
removing the first portion of the pumpable substance from the first pressure vessel and removing the second portion of pumpable substance from the second pressure vessel.

37. The method of claim 36, further comprising cooling the first portion of the pumpable substance after removing the first portion of the pumpable substance from the first high pressure vessel.

38. The method of claim 36 wherein heating the first portion of the pumpable substance includes transferring heat to the first portion of the pumpable substance from a third portion of the pumpable substance after the third portion has been removed from the first high pressure vessel.

39. The method of claim 36 wherein each pressure vessel has a isolator therein for isolating pumpable substance from a pressurized fluid, further wherein pressurizing the first and second portions of the pumpable includes moving the first isolator according to a first isolator schedule and moving the second isolator according to a second isolator schedule with the first isolator schedule being offset from the second isolator schedule.

40. A method for pressure processing a pumpable substance, comprising:
controllably adjusting an amount of gas in the pumpable substance;
transferring a first portion of the pumpable substance to a first high pressure vessel;
transferring a second portion of the pumpable substance to a second high pressure vessel and operatively coupling the first and second vessels;
pressurizing the first portion of the pumpable substance in the first high pressure vessel according to a first schedule and pressurizing the second portion of the pumpable substance in the second vessel according to a second schedule with the first and second schedules offset from each other; and
removing the first portion of the pumpable substance from the first pressure vessel and removing the second portion of pumpable substance from the second pressure vessel.

41. The method of claim 40 wherein controllably adjusting an amount of gas includes removing gas from the pumpable substance by applying a vacuum to the pumpable substance.

42. The method of claim 40 wherein controllably adjusting an amount of gas includes removing air from the pumpable substance.

43. The method of claim 40 wherein controllably adjusting an amount of gas includes adding carbon dioxide to the pumpable substance.

44. The method of claim 40 wherein controllably adjusting an amount of gas in the pumpable substance includes adding or removing a first portion of gas from the first portion of the pumpable substance before transferring the first portion of the pumpable substance to the first vessel, further comprising adding or removing a second portion of gas from the first portion of the pumpable substance after transferring the first portion of the pumpable substance from the first vessel.

45. The method of claim 40, further comprising selecting the gas to include carbon dioxide.

46. A method for pressure processing a pumpable substance with a pressurizing apparatus, the method comprising:
opening a first valve coupled to a high pressure cylinder to transfer the pumpable substance through the first valve and into the high pressure cylinder;
closing the first valve;
pressurizing the pumpable substance within the high pressure cylinder; and
detecting a flow of the pumpable substance past the closed first valve by detecting a portion of the pumpable substance in a region between the first valve and a second valve.

47. The method of claim 46 wherein detecting a flow of the pumpable substance includes detecting a pressure rise in the region between the first valve and the second valve.

48. The method of claim 46 wherein detecting a flow of the pumpable substance includes detecting a change in pH of material in the region between the first valve and the second valve.

49. The method of claim 46 wherein detecting a flow of the pumpable substance includes detecting a change in opacity of material in the region between the first valve and the second valve.

50. The method of claim 46, further comprising halting operation of the pressurizing apparatus in response to detecting the flow of the pumpable substance.

51. The method of claim 46 wherein the high pressure vessel is a first high pressure vessel, the pumpable substance is a first portion of pumpable substance and the apparatus further includes a second high pressure vessel, the method further comprising transferring the second portion of pumpable substance into the second vessel according to a schedule offset from a schedule for transferring the first portion of pumpable substance into the first pressure vessel.

52. A method for pressure processing a pumpable substance with a pressurizing apparatus, the method comprising:
opening a valve coupled to a high pressure vessel of the apparatus;
transferring the pumpable substance through the valve and into the high pressure vessel;
changing a position of at least one of the valve and a isolator in the high pressure vessel by driving the valve or the isolator with a pressurized fluid; and
monitoring a region between the value and the isolator to detect a flow of the pressurized fluid into the region between the valve and the isolator.

53. The method of claim 52 wherein monitoring the region includes detecting a change in pressure in the region between the valve and the isolator.

54. The method of claim 52 wherein monitoring the region includes detecting a change in pH of material between the valve and the isolator.

55. The method of claim 52, further comprising halting operation of the pressurizing apparatus in response to detecting the flow of the pressurized fluid.

56. The method of claim 52 wherein the high pressure vessel is a first high pressure vessel, the pumpable substance is a first portion of pumpable substance and the apparatus further includes a second high pressure vessel, the method further comprising transferring a second portion of pumpable substance into the second vessel according to a schedule offset from a schedule for transferring the first portion of pumpable substance into the first pressure vessel.

57. A method for pressure processing a pumpable substance in a pressurizing apparatus having first and second pressure vessels, the method comprising:
introducing a first portion of the pumpable substance to the first vessel according to a first schedule and introducing a second portion of the pumpable substance to the second vessel according to a second schedule offset from the first schedule;
initiating pressurization of the first portion of the pumpable substance according to a selected pressurizing procedure;
monitoring an actual pressurizing procedure of the first portion of the pumpable substance; and
upon detecting a deviation between the selected pressurizing procedure and the actual pressurizing procedure, diverting at least some of the first portion of the pumpable substance away from a receptacle for pumpable substance pressurized.

58. The method of claim 57 wherein introducing the first portion of the pumpable substance includes supplying the first portion from a source of pumpable substance and diverting the first portion includes returning the first portion to the source.

59. The method of claim 57 wherein introducing the first portion of the pumpable substance includes supplying the first portion from a source of pumpable substance and diverting the first portion includes moving the first portion to a receptacle different than the source.

60. The method of claim 57 wherein monitoring an actual pressurizing procedure includes detecting a leak of the first portion of the pumpable substance from the first vessel.

61. The method of claim 57 wherein monitoring an actual pressurizing procedure includes detecting a leak of a pressurizing fluid into the first vessel.

62. The method of claim 61 wherein detecting a leak includes detecting a leak of pressurizing fluid from one side of an isolator within the vessel to another side of the isolator.

63. The method of claim 61 wherein detecting a leak includes detecting a leak of pressurizing fluid from a valve coupled to the vessel.

64. A method for cleaning a vessel used for high pressure processing a pumpable substance, the vessel including an isolator having a flow channel extending through isolator from a first side of the isolator to a second side of the isolator, the method comprising:
introducing a pumpable substance into a region of the vessel adjacent one of the first and second sides of the isolator;
introducing a high pressure fluid into a region of the vessel adjacent the other of the first and second sides of the isolator;
removing the pumpable substance from the vessel; and
passing a cleansing fluid from the first side of the isolator through the flow channel to the second side of the isolator.

65. The method of claim 64 wherein the vessel has a first end and a second end spaced apart from the first end, further wherein the isolator is movable within the vessel toward and away from the first and second ends, further comprising moving the isolator toward the first end to clean a portion of the vessel proximate to the first end.

66. The method of claim 59 wherein the isolator includes a piston and passing the cleansing fluid includes passing the cleansing fluid from the first side of the piston to the second side of the piston.

67. A method for pressurizing a pumpable substance, comprising:
introducing the pumpable substance to a first region of a pressure vessel;
introducing a pressurizing fluid having a non-zero pH to a second region of the vessel, the second region being separated from the first region of the vessel by an isolator; and
pressurizing the pumpable substance by biasing the isolator toward the pumpable substance with the pressurized fluid.

68. The method of claim 67, further comprising moving the isolator within the vessel to transfer at least a portion of the pressurized fluid from the second region of the vessel to a wall of the vessel in the first region of the vessel for cleaning the wall in the first region of the vessel.

69. The method of claim 67 wherein selecting the pressurizing fluid includes selecting the pressurizing fluid to include citric acid.

70. The method of claim 67, further comprising:
removing the pumpable substance from the vessel; and
scrubbing an interior wall of the pressure vessel by moving the isolator within the vessel while a cleansing fluid remains in the second region of the vessel.

71. The method of claim 70, further comprising selecting the cleansing fluid to include the pressurizing fluid.

72. A method for pressure processing a pumpable substance, comprising:
introducing the pumpable substance to a first region of a pressure vessel;
introducing a pressurized fluid to a second region of the vessel, the second region being separated from the first region of the vessel by a isolator;
pressurizing the pumpable substance by biasing the isolator toward the pumpable substance with the pressurized fluid;
removing the pumpable substance from the vessel; and
moving the isolator axially within the vessel without the pumpable substance in the vessel to scrub an interior wall of the vessel.

73. The method of claim 72 wherein moving the isolator includes slideably engaging the isolator with the interior wall of the vessel.

74. The method of claim 72 wherein moving the isolator includes transferring a portion of the pressurized fluid from a portion of the interior wall in the second region of the vessel to a portion of the interior wall in the first region of the vessel.

75. A method for determining a volume of material transferred into or out of a high pressure vessel of a pressurizing apparatus, the high pressure vessel having an isolator dividing the vessel between a first region and a second region, the isolator being movable within the vessel, the method comprising:
introducing a portion of a first substance into the first region of the vessel to move the isolator and reduce a volume of the second region of the vessel;
removing a portion of a second substance from the second region of the vessel; and
measuring a quantity of one of the portions; and
determining a quantity of the other portion based on the quantity of the one portion.

76. The method of claim 75 wherein measuring a quantity of one of the portions includes measuring a volume of the portion of the first substance and determining a quantity of the other portion includes equating the volume of the portion of the first substance with a volume of the portion of the second substance.

77. The method of claim 76 wherein measuring a volume of the one portion includes passing the portion of the first substance through a flow meter.

78. The method of claim 75, further comprising controlling a rate at which the first substance is removed from the vessel in response to determining the quantity of the second substance removed from the vessel.

79. The method of claim 75 wherein measuring a quantity of one of the portions includes measuring a volume of a pressurizing fluid introduced into the first region of the vessel and determining a quantity of the other portion includes determining a quantity of a pumpable substance removed from the second region of the vessel.

80. The method of claim 75 wherein the high pressure vessel is a first high pressure vessel and the apparatus includes a second high pressure vessel having a moveable isolator dividing the second vessel between a first region and a second region, further wherein the first substance is a first portion of the first substance, the method further comprising transferring a second portion of the first substance to the second vessel according to a schedule offset from a schedule for transferring the first portion of the first substance into the first pressure vessel.
